(19) United States
(12) Patent Application Publication
(10) Pub. No.: US 2026/0309850 A1
(43) Pub. Date: Oct. 8, 2026

(54) APPARATUS FOR DETECTING CONTAMINATION OF DISTANCE MEASURING SENSOR, OPERATING METHOD THEREOF, AND VEHICLE INCLUDING SAME

(71) Applicants: Hyundai Motor Company, Seoul (KR); Kia Corporation, Seoul (KR); The Regents of the University of California, Oakland, CA (US)

(72) Inventors: Hun Jae Kim, Hwaseong, Gyeonggi-do (KR); Joon Woo Lee, Hwaseong, Gyeonggi-do (KR); Ju Hong Jeon, Hwaseong, Gyeonggi-do (KR); Ki Heon Choi, Hwaseong, Gyeonggi-do (KR); Jin Hyeok Gong, Hwaseong, Gyeonggi-do (KR); Saba Farahani, Irvine, CA (US); Jaeyun Lee, Irvine, CA (US); Yoonjin Won, Irvine, CA (US)

(21) Appl. No.: 19/098,760

(22) Filed: Apr. 2, 2025

(51) Int. Cl. G01S 7/497; G01S 17/89; G01S 17/931

(52) U.S. Cl. CPC G01S 7/497; G01S 17/89; G01S 17/931; G01S 2007/4977

(57) ABSTRACT

An apparatus is configured to detect contaminants of a distance measuring sensor that detects an object around a vehicle in order to assist in effective removal of the contaminants. The apparatus is mounted on the vehicle and includes a communication module and a processor for receiving a point cloud output from the distance measuring sensor, extracting a near-field point cloud for detecting the contamination with respect to the distance measuring sensor from the point cloud, determining feature vectors for the near-field point cloud, and outputting a contamination detection result by inputting the feature vectors into a sensor contamination detection neural network model, wherein the near-field point cloud may correspond to a point cloud within a threshold distance preset for detecting the contamination of the distance measuring sensor.

### BACKGROUND

### (a) Technical Field

The present disclosure relates to an apparatus for detecting contamination of a distance measuring sensor, more particularly, to the apparatus for detecting contaminants of a distance measuring sensor in order to assist in effective removal of the contaminants, an operating method thereof, and a vehicle including the same.

### (b) Description of the Related Art

Various types of sensors are mounted in a vehicle. For example, distance measuring sensors are utilized to detect objects around the vehicle. Types of distance measuring sensors include LiDAR (Light Detection and Ranging), ultrasonic sensors, and the like.

When a distance measurement is not accurate due to contamination of the distance measuring sensor, a vehicle system based on the distance measuring sensor cannot operate properly. Accordingly, the vehicle cannot travel normally and the vehicle safety is threatened.

Therefore, it is important to remove contaminants when the distance measuring sensor is contaminated.

Furthermore, since the vehicle is exposed to external environments due to its intended use, there are various contaminants that can contaminate distance sensors, so it is required to devise a method to effectively remove these various types of contaminants.

The matters described as the background technology are only intended to enhance understanding of the background of the present disclosure, and do not constitute an acknowledgment that they correspond to prior art already known to those skilled in the art.

### SUMMARY

The present disclosure provides an apparatus for detecting contamination of a distance measuring sensor, an operating method thereof, and a vehicle including the same.

The present disclosure provides an apparatus for detecting contaminants with respect to a distance measuring sensor, an operating method thereof, and a vehicle including the same.

The present disclosure provides an apparatus for detecting current contaminants based on the characteristics of various contaminants obtained by analyzing point cloud data obtained for close-range light, an operating method thereof, and a vehicle including the same.

Technical tasks to be achieved in the present disclosure are not limited to the technical tasks mentioned above, and other technical tasks not mentioned may be clearly understood by those skilled in the art to which the present disclosure pertains from the following description.

An apparatus for detecting contamination of a distance measuring sensor according to an exemplary embodiment of the present disclosure for achieving the objectives described above is mounted on a vehicle and includes a communication module and a processor for receiving a point cloud output from the distance measuring sensor mounted in the vehicle through the communication module, extracting a near-field point cloud for detecting the contamination with respect to the distance measuring sensor from the point cloud, determining feature vectors for the near-field point cloud, and outputting a contamination detection result by inputting the feature vectors into a sensor contamination detection neural network model.

According to another aspect of the present disclosure, an apparatus mounted in a vehicle for detecting contamination includes: a communication module; a distance measuring sensor configured to detect an object around the vehicle, and output a point cloud through the communication module; and a processor configured to: receive the point cloud output from the distance measuring sensor, extract a near-field point cloud for detecting the contamination with respect to the distance measuring sensor from the point cloud, determine feature vectors for the near-field point cloud, and output a contamination detection result by inputting the feature vectors into a sensor contamination detection neural network model.

According to an exemplary embodiment of the present disclosure, the near-field point cloud may correspond to a point cloud within a threshold distance preset for detecting the contamination with respect to the distance measuring sensor.

According to an exemplary embodiment of the present disclosure, the sensor contamination detection neural network model may be trained based on characteristics obtained by analyzing contamination data obtained in relation to the distance measuring sensor while driving the vehicle in various environments.

According to an exemplary embodiment of the present disclosure, the distance measuring sensor may include a LiDAR (Light Detection and Ranging) sensor.

According to an exemplary embodiment of the present disclosure, the processor may output contamination status information and contaminant information as the contamination detection result based on the sensor contamination detection neural network model.

According to an exemplary embodiment of the present disclosure, the processor may output a non-contamination flag or a contamination flag as the contamination status information, and may output a rainfall contamination flag, a snowfall contamination flag, a snow removal material contamination flag, a dust contamination flag, an insect contamination flag, or a fog contamination flag as the contaminant information, based on the sensor contamination detection neural network model.

According to an exemplary embodiment of the present disclosure, the processor detects blockage contamination with respect to the distance measuring sensor.

As a method of operating an apparatus mounted in a vehicle for detecting contamination of a distance measuring sensor, the method of operating an apparatus for detecting contamination of a distance measuring sensor according to an exemplary embodiment of the present disclosure includes, by a processor of the apparatus, receiving a point cloud output from the distance measuring sensor through a communication module, extracting a near-field point cloud for detecting the contamination with respect to the distance measuring sensor from the point cloud, determining feature vectors for the near-field point cloud, and outputting a contamination detection result by inputting the feature vectors into a sensor contamination detection neural network model.

According to a further aspect of the present disclosure, a method of operating an apparatus mounted in a vehicle for detecting contamination includes steps of: providing a distance measuring sensor configured to detect an object around the vehicle, the distance measuring sensor configured to communicate with a communication module; outputting, by the distance measuring sensor, a point cloud through the communication module; receiving, by a processor, the point cloud output from the distance measuring sensor through the communication module; extracting, by the processor, a near-field point cloud for detecting the contamination with respect to the distance measuring sensor from the point cloud; determining, by the processor, feature vectors for the near-field point cloud; and outputting, by the processor, a contamination detection result by inputting the feature vectors into a sensor contamination detection neural network model.

According to an exemplary embodiment of the present disclosure, the outputting the contamination detection result may include outputting contamination status information and contaminant information based on the sensor contamination detection neural network model.

According to an exemplary embodiment of the present disclosure, the outputting contamination status information and contaminant information may include outputting a non-contamination flag or a contamination flag as the contamination status information, and outputting a rainfall contamination flag, a snowfall contamination flag, a snow removal material contamination flag, a dust contamination flag, an insect contamination flag, or a fog contamination flag as the contaminant information, based on the sensor contamination detection neural network model.

A vehicle according to an exemplary embodiment of the present disclosure includes a distance measuring sensor for detecting an object around the vehicle; and an apparatus for detecting contamination of the distance measuring sensor, the apparatus including a processor for receiving a point cloud output from the distance measuring sensor, extracting a near-field point cloud for detecting the contamination with respect to the distance measuring sensor from the point cloud, determining feature vectors for the near-field point cloud, and outputting a contamination detection result by inputting the feature vectors into a sensor contamination detection neural network model.

According to yet a further aspect of the present disclosure, a vehicle includes: a distance measuring sensor configured to detect an object around the vehicle; and an apparatus configured to detect contamination of the distance measuring sensor, where the apparatus includes: a communication module; a distance measuring sensor configured to detect an object around the vehicle, and output a point cloud through the communication module; and a processor configured to: receive the point cloud output from the distance measuring sensor, extract a near-field point cloud for detecting the contamination with respect to the distance measuring sensor from the point cloud, determine feature vectors for the near-field point cloud, and output a contamination detection result by inputting the feature vectors into a sensor contamination detection neural network model.

According to an exemplary embodiment of the present disclosure, the vehicle may further include a cleaning device provided in each of the distance measuring sensors, and a cleaning controller for controlling the cleaning device based on the contamination detection result to perform cleaning of the distance measuring sensors.

According to an exemplary embodiment of the present disclosure, the cleaning device may include an air cleaner composed of an air spray nozzle for spraying air, a wiper cleaner composed of a wiper, a washer cleaner composed of a washer fluid spray nozzle for spraying washer fluid, and a heater composed of a heating wire and a power source for supplying power to the heating wire.

According to an exemplary embodiment of the present disclosure, the cleaning controller may selectively drive the air cleaner, the wiper cleaner, the washer cleaner, and the heater based on the contamination detection result to perform the cleaning of the distance measuring sensor.

According to an exemplary embodiment of the present disclosure, the air spray nozzle, the wiper, the washer fluid spray nozzle, and the heating wire may be disposed at an edge of the outermost cover of the distance measuring sensor.

Specific details according to various examples of the present disclosure other than the means for solving the tasks mentioned above are included in the following description and drawings.

According to an exemplary embodiment of the present disclosure, an apparatus for detecting contamination of a distance measuring sensor, an operating method thereof, and a vehicle including the same are provided.

According to an exemplary embodiment of the present disclosure, an apparatus for detecting contaminants of a distance measuring sensor in detail, an operating method thereof, and a vehicle including the same are provided.

According to an exemplary embodiment of the present disclosure, an apparatus for detecting current contaminants in detail based on the characteristics of various contaminants obtained by analyzing point cloud data obtained for close-range light, an operating method thereof, and a vehicle including the same are provided.

When applying an apparatus for detecting contamination of a distance measuring sensor, and a method of operating the same according to an exemplary embodiment of the present disclosure to a vehicle, it is possible to detect contaminants of a distance measuring sensor mounted on the vehicle in detail. Accordingly, the contaminants can be effectively removed because proper cleaning may be performed according to the contaminants.

In addition, effective removal of contaminants not only improves the performance of vehicle systems based on distance measuring sensors, but also enhances the autonomous driving performance and safety of vehicles.

The effects obtainable in the present disclosure are not limited to the effects mentioned above, and other effects not mentioned will be clearly understood by those skilled in the art to which the present disclosure pertains from the description below.

### BRIEF DESCRIPTION OF THE DRAWINGS

The drawings attached below are for helping understanding of an exemplary embodiment of the present disclosure, and provide exemplary embodiments with a detailed description. However, the technical features of the present exemplary embodiment are not limited to a specific drawing, and the features disclosed in each drawing may be combined with each other to be configured as a new exemplary embodiment.

FIG. 1 is a view showing a configuration example of a vehicle 1 provided with an apparatus for detecting sensor contamination according to an exemplary embodiment of the present disclosure.

FIG. 2 is a view showing a configuration example of an apparatus 200 for detecting sensor contamination according to an exemplary embodiment of the present disclosure.

FIG. 3 is a view showing a configuration example of a cleaning controller 300 according to an exemplary embodiment of the present disclosure.

FIG. 4 is a view illustrating an operation of an apparatus 200 for detecting sensor contamination according to an exemplary embodiment of the present disclosure.

FIG. 5 is a view illustrating an operation of cleaning a sensor according to an exemplary embodiment of the present disclosure.

### DETAILED DESCRIPTION OF THE DISCLOSURE

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The terminology used herein is for the purpose of describing particular embodiments only and is not intended to be limiting of the present disclosure. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Throughout the specification, unless explicitly described to the contrary, the word “comprise” and variations such as “comprises” or “comprising” will be understood to imply the inclusion of stated elements but not the exclusion of any other elements. In addition, the terms “unit”, “-er”, “-or”, and “module” described in the specification mean units for processing at least one function and operation, and can be implemented by hardware components or software components and combinations thereof.

Further, the control logic of the present disclosure may be embodied as non-transitory computer readable media on a computer readable medium containing executable program instructions executed by a processor, controller or the like. Examples of computer readable media include, but are not limited to, ROM, RAM, compact disc (CD)-ROMs, magnetic tapes, floppy disks, flash drives, smart cards and optical data storage devices. The computer readable medium can also be distributed in network coupled computer systems so that the computer readable media is stored and executed in a distributed fashion, e.g., by a telematics server or a Controller Area Network (CAN).

In describing exemplary embodiments disclosed in the present specification, the detailed description thereof will be omitted when it is determined that a detailed description of a related known technology may obscure the gist of the exemplary embodiments disclosed in the present specification. In addition, the accompanying drawings are only intended to facilitate easy understanding of the exemplary embodiments disclosed in the present specification, and the technical ideas disclosed in the present specification are not limited by the accompanying drawings, and should be understood to include all modifications, equivalents, or substitutes included in the ideas and technical scope of the present disclosure.

Terms including ordinal numbers, such as first and second, may be used to describe various components, but the components are not limited by the terms. The terms are used only for the purpose of distinguishing one component from another component.

Singular expressions include plural expressions unless the context clearly indicates otherwise.

The suffixes “module” and “unit” used for components in the following description are assigned or used interchangeably only for the convenience of writing the specification, and do not have distinct meanings or roles in and of themselves.

When it is mentioned that a component is “connected” or “linked” to another component, it should be understood that it may be directly connected or linked to that other component, but that there may be other components in between. On the other hand, when it is mentioned that a component is “directly connected” or “directly linked” to another component, it should be understood that there are no other components in between.

In addition, a unit or control unit included in the name is a term widely used to name a controller for controlling a vehicle-specific function, but does not mean a generic function unit.

The controller may include a communication device for communicating with other controllers or sensors for control of functions in charge, a memory for storing an operating system or logic commands and input/output information, and one or more processors for performing determination, calculation, and decision necessary for control of functions in charge.

Any number of components in any of the configurations described in the present disclosure or various components may be included in the disclosure described in the present specification. Components may include any combination of feature units described in the present specification and may be arranged in any of the various configurations described in the present specification. The concepts of not only the structure and arrangement but also their usage and operation of the components of the present disclosure may be applied to any number of exemplary embodiments in any combination as well as to the specific exemplary embodiments discussed in the present specification. Exemplary embodiments including those having various feature units of various arrangements are described below with reference to the drawings.

Hereinafter, various exemplary embodiments disclosed in the present specification will be described in detail with reference to the accompanying drawings, and identical or similar components will be assigned the same reference numbers regardless of the drawing code, and duplicate descriptions thereof will be omitted.

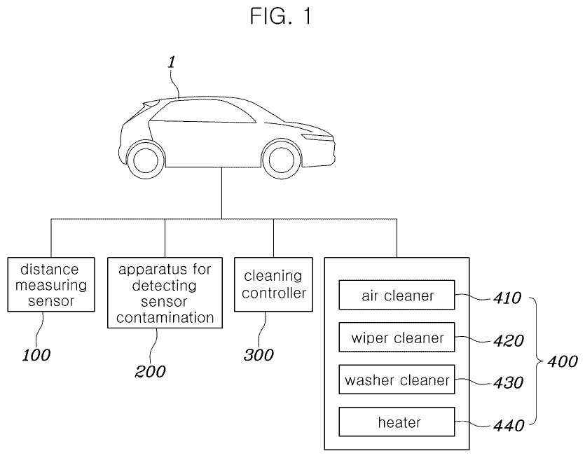

FIG. 1 is a view showing a configuration example of a vehicle 1 provided with an apparatus for detecting sensor contamination according to an exemplary embodiment of the present disclosure.

Referring to FIG. 1, a vehicle 1 according to an exemplary embodiment of the present disclosure may include a distance measuring sensor 100, an apparatus 200 for detecting sensor contamination, a cleaning controller 300, and a cleaning device 400, but the configuration of the vehicle 1 is not limited thereto.

According to an exemplary embodiment, the apparatus 200 for detecting sensor contamination, the cleaning controller 300, and the cleaning device 400 may implement a sensor cleaning system in the vehicle 1.

For example, the distance measuring sensor 100, the apparatus 200 for detecting sensor contamination, the cleaning controller 300, and the cleaning device 400 may communicate based on a vehicle communication protocol. For example, the vehicle communication protocol may include a local interconnect network (LIN), a controller area network (CAN), FlexRay, Ethernet, and the like, and the type of the vehicle communication protocol is not limited thereto.

According to an exemplary embodiment of the present disclosure, the distance measuring sensor 100 may detect an object around the vehicle 1. For example, the distance measuring sensor 100 may be a LiDAR (Light Detection and Ranging), but the distance measuring sensor 100 is not limited thereto.

The distance measuring sensor 100 may detect an object around the vehicle 1 by emitting a light pulse (or a laser pulse), and may output a point cloud for the detected object when detecting the object.

The apparatus 200 for detecting sensor contamination may determine whether the distance measuring sensor 100 is contaminated based on the point cloud output from the distance measuring sensor 100. For example, the apparatus 200 for detecting sensor contamination may detect blockage contamination of the distance measuring sensor 100.

The researchers of the present disclosure have analyzed the point cloud with respect to the near-field reflected pulse related to the distance measuring sensor and confirmed that a near-field point cloud is related to the blockage contamination of the distance measuring sensor. Accordingly, the researchers of the present disclosure have proposed a method of using the near-field point cloud to detect the contamination of the distance measuring sensor.

According to an exemplary embodiment, the apparatus 200 for detecting sensor contamination may extract a point cloud (hereinafter, referred to as the near-field point cloud) related to a light pulse (hereinafter, referred to as a near-field reflected pulse) reflected in a close range from the point cloud.

For example, the apparatus 200 for detecting sensor contamination may extract a point cloud within a preset threshold distance. For example, the threshold distance may be a close range (ex, 0.5 m, 0.7 m, 1 m, etc.), and the threshold distance is not limited thereto.

In an exemplary embodiment, the threshold distance may be set based on data collection and experiments performed in various environments for contamination detection of the distance measuring sensor 100, and may be set in various ways depending on an application.

According to an exemplary embodiment, the apparatus 200 for detecting sensor contamination may determine a feature vector for the near-field point cloud.

For example, the feature vector may include the number of points included in the near-field point cloud, an average distance for the near-field point cloud, an average and variance value of the near-field point cloud, an average of a distances between the points included in the near-field point cloud, an average of a horizontal angle of the points included in the near-field point cloud, an average of a vertical angle of the points included in the near-field point cloud, an average and variance value for the wavelength of the near-field point cloud, a eigenvector of a correlation coefficient for each point of the near-field point cloud, and the like, but the type of the feature vector is not limited thereto.

For example, the number of points included in the near-field point cloud may be the most important indicator for determining whether the distance measuring sensor 100 is contaminated, and as the number is higher, the possibility of contamination and the concentration of contamination are higher.

For example, as the average distance for the near-field point cloud is larger, the possibility of contamination and the concentration of contamination are larger. For example, as the average and variance value of the near-field point cloud is larger, the possibility of contamination and the concentration of contamination are larger.

For example, the average of a distance between the points included in the near-field point cloud, the average of a horizontal angle of the points included in the near-field point cloud, and the average of a vertical angle of the points included in the near-field point cloud may be numerical values for point cloud patterns that vary depending on contamination.

For example, the average and variance value for the wavelength of the near-field point cloud may be characteristics related to the wavelength, and since the short wavelength cannot pass through the contamination surface, the possibility of contamination and the concentration of contamination are higher, as the near-field point cloud has longer wavelength characteristics.

For example, the eigenvector of a correlation coefficient for each point of the near-field point cloud may be characteristics of easily distinguishing contamination patterns.

According to an exemplary embodiment, the apparatus 200 for detecting sensor contamination may input the determined feature vectors into a neural network model (or a neural network algorithm) to determine whether there is the near-field point cloud-related contamination and what contaminants. In other words, the apparatus 200 for detecting sensor contamination may input the determined feature vectors into the neural network model and determine whether the distance measuring sensor 100 is contaminated and what contaminants.

For example, the neural network model may be k-nearest neighbors (kNN) models, random forest (RF) models, deep neural network (DNN) models, and the like, but the type of the neural network models are not limited thereto.

In an exemplary embodiment, the neural network model may be a model trained to detect the contamination of the distance measuring sensor 100, and may be hereinafter referred to as a “sensor contamination detection neural network model”.

In an exemplary embodiment, the sensor contamination detection neural network model may be trained based on characteristics obtained by analyzing contamination data obtained in relation to the distance measuring sensor while driving the vehicle in various environments.

For example, in order to obtain data used for training the sensor contamination detection neural network models, the vehicle may drive in a mountainous area, a humid area, a dry area, a snowy area, a rainy area, a foggy area, and the like, and obtain data in various climates.

According to an exemplary embodiment, the apparatus 200 for detecting sensor contamination may output information on a contamination detection result to the cleaning controller 300.

Herein, the information on the contamination detection result may include information on whether the distance measuring sensor 100 is contaminated. In addition, the information on the contamination detection result may include information on contaminants (contaminant information) when the distance measuring sensor 100 is contaminated.

For example, the apparatus 200 for detecting sensor contamination may output to the cleaning controller 300 a message of the contamination detection result including a contamination status flag and a contaminant type flag.

For example, when the distance measuring sensor 100 is not contaminated, the contamination status information may include a non-contamination flag, and when the distance measuring sensor 100 is contaminated, the contamination status information may include a contamination flag.

For example, depending on the contaminants, the contaminant information may include a flag related to contamination caused by rainfall (a rainfall contamination flag), a flag related to contamination caused by snowfall (a snowfall contamination flag), a flag related to contamination caused by snow removal material (a snow removal material contamination flag), a flag related to contamination caused by dust (a dust contamination flag), a flag related to contamination caused by insects (an insect contamination flag), and a flag related to contamination caused by fog (a fog contamination flag).

The cleaning controller 300 may control the cleaning device 400 based on the information on the contamination detection result output from the apparatus 200 for detecting sensor contamination.

According to an exemplary embodiment, the cleaning controller 300 may determine whether the distance measuring sensor 100 is contaminated based on the contamination status information. According to an exemplary embodiment, the cleaning controller 300 may control the cleaning device 400 to perform cleaning of the distance measuring sensor 100 when determined that the distance measuring sensor 100 is contaminated.

According to an exemplary embodiment, the cleaning controller 300 may select a plurality of cleaners 410, 420, 430, 440 of the cleaning device 400 based on the contaminant information included in the information on the contamination detection result and may control the selected cleaner to perform the cleaning of the distance measuring sensor 100.

According to an exemplary embodiment, the cleaning controller 300 may receive status information for each cleaner from the cleaning device 400. For example, the status information may include information on whether each cleaner operates normally. For example, the status information may include an air capacity of the air cleaner 410, information on whether the wiper cleaner 420 is damaged, a washer fluid capacity of the washer cleaner 430, a temperature of the heater 440, and the like, and the type of the status information is not limited thereto.

For example, the cleaning controller 300 may include an upper controller and a plurality of lower controllers.

In an exemplary embodiment, the upper controller may receive the information on the contamination detection result from the apparatus 200 for detecting sensor contamination by communicating with the apparatus 200 for detecting sensor contamination and may output a command to the lower controllers based on the information on the contamination detection result. For example, the command may include an operation start command and an operation end command, and the type of the command is not limited thereto.

In an exemplary embodiment, the lower controllers may control the matched cleaners 410, 420, 430, 440 according to the command of the upper controller. For example, the lower controllers may include an air cleaner controller for controlling the air cleaner 410, a wiper cleaner controller for controlling the wiper cleaner 420, a washer cleaner controller for controlling the washer cleaner 430, and a heater controller for controlling the heater 440.

For example, when the cleaning controller 300 serves only as an upper controller, each of the plurality of cleaners 410, 420, 430, 440 may include a controller linked to the cleaning controller 300.

For example, when the contaminant information includes the flag related to contamination caused by rainfall, the cleaning controller 300 may drive the air cleaner 410. According to an exemplary embodiment, the cleaning controller 300 may drive the wiper cleaner 420 when the cleaning for the distance measuring sensor 100 is not performed due to insufficient air capacity.

For example, when the contaminant information includes the flag related to contamination caused by snowfall, the cleaning controller 300 may drive the heater 440 in order to prevent snow from freezing. According to an exemplary embodiment, the cleaning controller 300 may drive one or more of the air cleaner 410 and the wiper cleaner 420 in order to remove fluids.

For example, when the contaminant information includes the flag related to contamination caused by snow removal material, the cleaning controller 300 may drive at least one of the air cleaner 410 and the washer cleaner 430 as well as the wiper cleaner 420 because the snow removal material contains sodium (NaCl) and is not easy to remove due to high adhesive strength.

For example, when the contaminant information includes the flag related to contamination caused by dust, the cleaning controller 300 may first drive at least one of the air cleaner 410 and the washer cleaner 430 because air cleaning and washer cleaning is not easy when the dust is hardened. According to an exemplary embodiment, the cleaning controller 300 may additionally drive the wiper cleaner 420.

For example, when the contaminant information includes the flag related to contamination caused by insects, the cleaning controller 300 may drive the wiper cleaner 420 because the contamination by the insects is not amenable to the air cleaning and the washer cleaning. Selectively, the cleaning controller 300 may additionally drive at least one of the air cleaner 410 and the washer cleaner 430.

As a configuration of removing the contaminants of the distance measuring sensor 100 of the vehicle 1, the cleaning device 400 may be installed in the vehicle 1 while individually matched with the distance measuring sensor 100.

According to an exemplary embodiment, the cleaning device 400 may operate based on the control of the cleaning controller 300.

For example, the cleaning device 400 may include an air cleaner 410, a wiper cleaner 420, a washer cleaner 430, and a heater 440, but the configuration of the cleaning device 400 is not limited thereto.

The air cleaner 410 may be implemented in the vehicle 1 in order to spray air and remove the contaminants from the distance measuring sensor 100. For example, the air cleaner 410 may include one or more of air spray nozzles disposed at an inner or outer edge of the outermost cover of the distance measuring sensor 100 to spray air toward the center of the distance measuring sensor 100.

The wiper cleaner 420 may be implemented in the vehicle 1 in order to remove the contaminants of the distance measuring sensor 100 by using a wiper. For example, the wiper cleaner 420 may include one or more of wipers disposed at an inner or outer edge of the outermost cover of the distance measuring sensor 100.

The washer cleaner 430 may be implemented in the vehicle 1 in order to remove the contaminants of the distance measuring sensor 100 by spraying washer fluid. For example, the washer cleaner 430 may include one or more of washer fluid spray nozzles disposed at an inner or outer edge of the outermost cover of the distance measuring sensor 100 to spray the washer fluid toward the center of the distance measuring sensor 100.

The heater 440 may be implemented in the vehicle 1 in order to remove the contaminants of the distance measuring sensor 100 by generating heat. For example, the heater 440 may include a heating wire disposed at an inner or outer edge of the outermost cover of the distance measuring sensor 100, and a power source for supplying power to the heating wire. For example, the power source may be a power source pre-installed in the vehicle 1, or may be a separate power source for the heater 440. For example, the power source may be a battery, and various types of power components (e.g., breakers, etc.) may be installed between the power source and the heating wire.

According to an exemplary embodiment, the plurality of cleaners 410, 420, 430, 440 may remove the contaminants of the distance measuring sensor 100 alone under the control of the cleaning controller 300. According to an exemplary embodiment, the plurality of cleaners 410, 420, 430, 440 may remove the contaminants of the distance measuring sensor 100 in combination under the control of the cleaning controller 300.

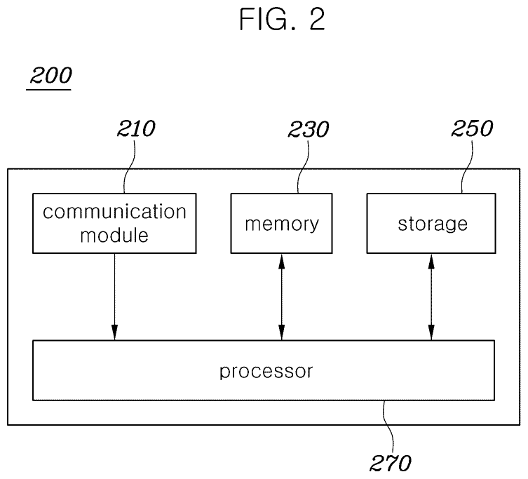

FIG. 2 is a view showing a configuration example of an apparatus 200 for detecting sensor contamination according to an exemplary embodiment of the present disclosure.

Referring to FIG. 2, the apparatus 200 for detecting sensor contamination may include a communication module 210, a memory 230, a storage 250, and a processor 270, and the configuration of the apparatus 200 for detecting sensor contamination is not limited thereto.

The communication module 210 may include a communication circuit implemented to communicate with the distance measuring sensor 100 based on a preset vehicle communication protocol. The communication module 210 may include a communication circuit implemented to communicate with the cleaning controller 300 based on a preset vehicle communication protocol.

The information received by the communication module 210 may be stored in the memory 230, stored in the storage 250, and transmitted to the processor 270.

The memory 230 may store algorithms (or software or programs), data, and the like necessary to perform functions of the apparatus 200 for detecting sensor contamination. For example, the memory 230 may store algorithms, data, and the like necessary for the apparatus 200 for detecting sensor contamination to perform the operations of detecting sensor contamination according to an exemplary embodiment of the present disclosure.

The storage 250 may store information generated or obtained according to the operations of the apparatus 200 for detecting sensor contamination. For example, the storage 250 may store the point cloud output from the distance measuring sensor 100.

For example, the memory 230 and the storage 250 may be implemented as at least one or more of storage media (or recording media) such as a flash memory, a hard disk, a secure digital card (an SD card), a random access memory (RAM), a static random access memory (SRAM), a read-only memory (ROM), a programmable read-only memory (PROM), an electrically erasable and programmable ROM (EEPROM), an erasable and programmable ROM (EPROM), a register, a removable disk, a web storage, and the like.

The processor 270 may perform the overall operations of the apparatus 200 for detecting sensor contamination. The processor 270 may detect whether the distance measuring sensor 100 is contaminated and what contaminants based on the point cloud provided from the distance measuring sensor 100 based on information or signals received through the communication module 210, algorithms/data stored in the memory 230, information stored in the storage 250, and the like.

To this end, the processor 270 may be a data processing device implemented with hardware having a circuit of a physical structure for executing desired operations. For example, the desired operations may include codes or instructions included in the program. For example, the data processing device implemented with hardware may include a microprocessor, a central processing unit, a processor core, a multi-core processor, a multiprocessor, an application-specific integrated circuit (ASIC), and a field programmable gate array (FPGA).

According to an exemplary embodiment, the processor 270 may extract the near-field point cloud from the point cloud output from the distance measuring sensor 100.

According to an exemplary embodiment, the processor 270 may determine the feature vectors for the near-field point cloud.

According to an exemplary embodiment, the processor 270 may output the contamination detection result by inputting the feature vectors into the sensor contamination detection neural network model. Herein, the processor 270 may output the contamination status information and the contaminant information as the contamination detection result.

For example, the processor 270 may output the non-contamination flag or the contamination flag as the contamination status information. For example, the processor 270 may output the rainfall contamination flag, the snowfall contamination flag, the snow removal material contamination flag, the dust contamination flag, the insect contamination flag, or the fog contamination flag as the contaminant information.

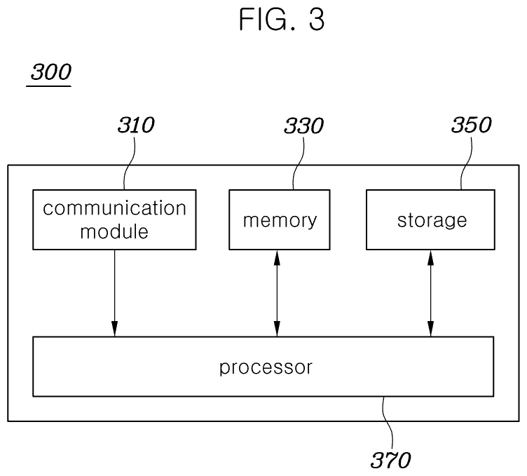

FIG. 3 is a view showing a configuration example of a cleaning controller 300 according to an exemplary embodiment of the present disclosure.

Referring to FIG. 3, the cleaning controller 300 may include a communication module 310, a memory 330, a storage 350, and a processor 370, but the configuration of the cleaning controller 300 is not limited thereto.

The communication module 310 may include a communication circuit implemented to communicate with the apparatus 200 for detecting sensor contamination based on a preset vehicle communication protocol. The communication module 310 may include a communication circuit implemented to communicate with the cleaning device 400 based on a preset vehicle communication protocol.

The information received by the communication module 310 may be stored in the memory 330, stored in the storage 350, and transmitted to the processor 370.

The memory 330 may store algorithms (or software or programs), data, and the like necessary to perform functions of the cleaning controller 300. For example, the memory 330 may store algorithms, data, and the like necessary for the cleaning controller 300 to perform a cleaning control operation according to an exemplary embodiment of the present disclosure.

The storage 350 may store information generated or obtained according to the operations of the cleaning controller 300. For example, the storage 350 may store state information on the cleaning device 400.

For example, the memory 330 and the storage 350 may be implemented as at least one or more of storage media (or recording media) such as a flash memory, a hard disk, a secure digital card (an SD card), a random access memory (RAM), a static random access memory (SRAM), a read-only memory (ROM), a programmable read-only memory (PROM), an electrically erasable and programmable ROM (EEPROM), an erasable and programmable ROM (EPROM), a register, a removable disk, a web storage, and the like.

The processor 370 may perform the overall operations of the cleaning controller 300. The processor 370 may control the cleaning device 400 based on information or signals received through the communication module 310, algorithm/data stored in the memory 330, information stored in the storage 350, and the like.

To this end, the processor 370 may be a data processing device implemented with hardware having a circuit of a physical structure for executing desired operations. For example, the desired operations may include codes or instructions included in the program. For example, the data processing device implemented with hardware may include a microprocessor, a central processing unit, a processor core, a multi-core processor, a multiprocessor, an application-specific integrated circuit (ASIC), and a field programmable gate array (FPGA).

According to an exemplary embodiment, the processor 370 may control the cleaning device 400 based on the information on the contamination detection result provided from the apparatus 200 for detecting sensor contamination.

According to an exemplary embodiment, when determining that the distance measuring sensor 100 is contaminated based on the contamination status information (a non-contamination flag or a contamination flag) included in the information on the contamination detection result, the processor 370 may determine a cleaner to be controlled based on the contaminant information (a rainfall contamination flag, a snowfall contamination flag, a snow removal material contamination flag, a dust contamination flag, or an insect contamination flag) included in the information on the contamination detection result, and then drive the determined cleaner.

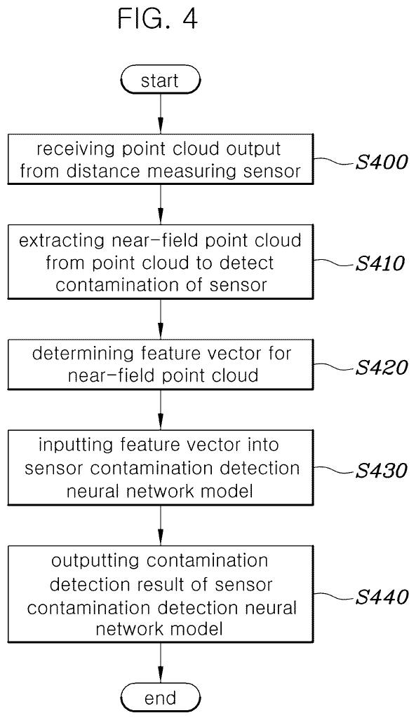

FIG. 4 is a view illustrating an operation of an apparatus 200 for detecting sensor contamination according to an exemplary embodiment of the present disclosure.

Referring to FIG. 4, the apparatus 200 for detecting sensor contamination may receive the point cloud output from the distance measuring sensor 100 (S400).

Thereafter, the apparatus 200 for detecting sensor contamination may extract the near-field point cloud from the point cloud in order to detect the contamination with respect to the distance measuring sensor 100 (S410).

Thereafter, the apparatus 200 for detecting sensor contamination may determine the feature vectors for the near-field point cloud (S420).

Thereafter, the apparatus 200 for detecting sensor contamination may input the feature vectors into the sensor contamination detection neural network model (S430), and output the contamination detection result of the sensor contamination detection neural network model (S440).

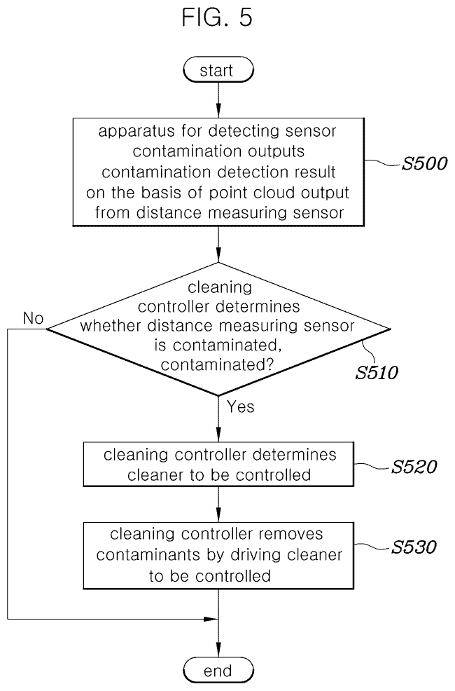

FIG. 5 is a view illustrating an operation of cleaning a sensor according to an exemplary embodiment of the present disclosure.

Referring to FIG. 5, the apparatus 200 for detecting sensor contamination may receive the point cloud output from the distance measuring sensor 100 and may output the contamination detection result based on the received point cloud (S500).

The detailed operations of the step S500 may be performed by the steps S400 to S440 of FIG. 4, and a detailed description thereof will be omitted.

The contamination detection result output by the apparatus 200 for detecting sensor contamination may be transmitted to the cleaning controller 300.

Thereafter, the cleaning controller 300 may determine whether the distance measuring sensor 100 is contaminated based on the contamination status information included in the contamination detection result (S510).

When it is determined that the distance measuring sensor 100 is contaminated (S510—Yes), the cleaning controller 300 may determine the cleaner to be controlled based on the contaminant information included in the contamination detection result (S520).

Thereafter, the cleaning controller 300 may remove the contaminants of the distance measuring sensor 100 by driving the cleaner to be controlled (S530).

When it is determined that the distance measuring sensor 100 is not contaminated (S510—No), the cleaning controller 300 may finish the cleaning operation.

Although illustrated and described in connection with a specific exemplary embodiment of the present disclosure, it is obvious to those skilled in the art that the present disclosure may be variously modified and altered to the extent that it does not deviate from the technical idea of the present disclosure provided by the following claims.

What is claimed is:

1. An apparatus mounted in a vehicle for detecting contamination, the apparatus comprising:
a communication module;
a distance measuring sensor configured to detect an object around the vehicle, and output a point cloud through the communication module; and
a processor configured to:
receive the point cloud output from the distance measuring sensor,
extract a near-field point cloud for detecting the contamination with respect to the distance measuring sensor from the point cloud,
determine feature vectors for the near-field point cloud, and
output a contamination detection result by inputting the feature vectors into a sensor contamination detection neural network model.

2. The apparatus of claim 1, wherein the near-field point cloud corresponds to a point cloud within a threshold distance preset for detecting the contamination with respect to the distance measuring sensor.

3. The apparatus of claim 1, wherein the sensor contamination detection neural network model is trained based on characteristics obtained by analyzing contamination data obtained in relation to the distance measuring sensor while driving the vehicle in various environments.

4. The apparatus of claim 1, wherein the distance measuring sensor comprises a LiDAR (Light Detection and Ranging) sensor.

5. The apparatus of claim 1, wherein the processor is configured to output contamination status information and contaminant information as the contamination detection result based on the sensor contamination detection neural network model.

6. The apparatus of claim 5, wherein the processor is configured to output a non-contamination flag or a contamination flag as the contamination status information, and output a rainfall contamination flag, a snowfall contamination flag, a snow removal material contamination flag, a dust contamination flag, an insect contamination flag, or a fog contamination flag as the contaminant information, based on the sensor contamination detection neural network model.

7. The apparatus of claim 1, wherein the processor is configured to detect blockage contamination with respect to the distance measuring sensor.

8. A method of operating an apparatus mounted in a vehicle for detecting contamination, the method comprising:
providing a distance measuring sensor configured to detect an object around the vehicle, the distance measuring sensor configured to communicate with a communication module;
outputting, by the distance measuring sensor, a point cloud through the communication module;
receiving, by a processor, the point cloud output from the distance measuring sensor through the communication module;
extracting, by the processor, a near-field point cloud for detecting the contamination with respect to the distance measuring sensor from the point cloud;
determining, by the processor, feature vectors for the near-field point cloud; and
outputting, by the processor, a contamination detection result by inputting the feature vectors into a sensor contamination detection neural network model.

9. The method of claim 8, wherein the near-field point cloud corresponds to a point cloud within a threshold distance preset for detecting the contamination with respect to the distance measuring sensor.

10. The method of claim 8, wherein the sensor contamination detection neural network model is trained based on characteristics obtained by analyzing contamination data obtained in relation to the distance measuring sensor while driving the vehicle in various environments.

11. The method of claim 8, wherein the distance measuring sensor comprises a LiDAR (Light Detection and Ranging) sensor.

12. The method of claim 8, wherein the outputting the contamination detection result comprises outputting contamination status information and contaminant information based on the sensor contamination detection neural network model.

13. The method of claim 12, wherein the outputting contamination status information and contaminant information comprises outputting a non-contamination flag or a contamination flag as the contamination status information, and outputting a rainfall contamination flag, a snowfall contamination flag, a snow removal material contamination flag, a dust contamination flag, an insect contamination flag, or a fog contamination flag as the contaminant information, based on the sensor contamination detection neural network model.

14. The method of claim 8, wherein the detecting the contamination with respect to the distance measuring sensor comprises detecting blockage contamination with respect to the distance measuring sensor.

15. A vehicle, comprising:
a distance measuring sensor configured to detect an object around the vehicle; and
an apparatus configured to detect contamination of the distance measuring sensor, the apparatus comprising:
a communication module;
the distance measuring sensor configured to output a point cloud through the communication module; and
a processor configured to:
receive the point cloud output from the distance measuring sensor,
extract a near-field point cloud for detecting the contamination with respect to the distance measuring sensor from the point cloud,
determine feature vectors for the near-field point cloud, and
output a contamination detection result by inputting the feature vectors into a sensor contamination detection neural network model.

16. The vehicle of claim 15, wherein the distance measuring sensor comprises a LiDAR (Light Detection and Ranging) sensor.

17. The vehicle of claim 15, further comprising:
a cleaning device provided in each of the distance measuring sensors; and
a cleaning controller configured to control the cleaning device based on the contamination detection result to perform cleaning of the distance measuring sensor.

18. The vehicle of claim 17, wherein the cleaning device comprises:
an air cleaner composed of an air spray nozzle configured to spray air;
a wiper cleaner composed of a wiper;
a washer cleaner composed of a washer fluid spray nozzle configured to spray washer fluid; and
a heater composed of a heating wire and a power source configured to supply power to the heating wire.

19. The vehicle of claim 18, wherein the cleaning controller is configured selectively to drive the air cleaner, the wiper cleaner, the washer cleaner, and the heater based on the contamination detection result to perform the cleaning of the distance measuring sensor.

20. The vehicle of claim 17, wherein the air spray nozzle, the wiper, the washer fluid spray nozzle, and the heating wire are disposed at an edge of the outermost cover of the distance measuring sensor.
